(19) United States
(12) Patent Application Publication
(10) Pub. No.: US 2011/0300859 A1
(43) Pub. Date: Dec. 8, 2011

(54) WIRELESS TERMINAL APPARATUS AND METHOD OF CONTROLLING THE SAME

(75) Inventor: Hiroshi Takeda, Kanagawa (JP)

(73) Assignee: KYOCERA CORPORATION, Kyoto (JP)

(21) Appl. No.: 13/154,729

(22) Filed: Jun. 7, 2011

(30) Foreign Application Priority Data
Jun. 7, 2010 (JP) 2010-129994

(51) Int. Cl. H04W 56/00; H04W 4/00

(52) U.S. Cl. 455/426.1

(57) ABSTRACT

An object of the present invention is to provide a wireless communication terminal and a method of controlling the same, which can reduce the time taken for activating a second communication system when transitioning from communication via a first communication system to communication via the second communication system. A cellular telephone apparatus includes: an acquisition unit that obtains system time of a CDMA communication system by synchronizing with the CDMA communication system prior to activating an LTE communication system in a case in which communication is performed via the LTE communication system; a calculation unit that calculates a difference between the system time of the LTE communication system and the system time of the CDMA communication system; and a transition unit that calculates the system time of the CDMA communication system based on the system time of the LTE communication system and the calculated difference, and synchronizes with the CDMA communication system based on the calculated system time, in a case of transitioning from communication via the LTE communication system to communication via the CDMA communication system.

This application is based on and claims the benefit of priority from Japanese Patent Application No. 2010-129994 filed on 7 Jun. 2010, the content of which is incorporated herein by reference.

### BACKGROUND OF THE INVENTION

1. Field of the Invention

The present invention relates to a wireless terminal apparatus that can communicate with a plurality of communication systems, and to a method of controlling the wireless terminal apparatus.

2. Related Art

In recent years, in addition to a communication system of a circuit switched (CS: Circuit Switched) standard (for example, CDMA), a communication system of an LTE (Long Term Evolution) standard has been introduced as a communication system utilized by a wireless terminal apparatus such as a cellular telephone device.

However, the wireless terminal apparatus cannot simultaneously utilize both the communication system of the LTE standard and the communication system of the CDMA standard. Therefore, while utilizing LTE, a cellular telephone device has not been capable of obtaining a paging channel of CDMA, and thus has not been able to know whether there is an incoming call. Accordingly, a CS Fallback function is defined in LTE under 3GPP TS 23.272, and by way of this function, an incoming call request from CDMA can be reported via LTE (for example, see 3GPP TS 23.272 V10.1.0, “Circuit Switched (CS) fallback in Evolved Packet System (EPS); Stage 2,” 2010-09, and Japanese Unexamined Patent Application, Publication No. 2009-267996).

### SUMMARY OF THE INVENTION

However, even if the wireless terminal apparatus receives an incoming signal of CDMA via LTE, it was necessary to activate CDMA to search for a corresponding communication system, in order to initiate a telephone call. Therefore, a long period of time has been required until a user actually initiates a telephone call. Moreover, if the wireless terminal apparatus is outside a communication area of CDMA, a long period of time has also been required until determining failure of incoming call processing.

An object of the present invention is to provide a wireless communication apparatus and a method of controlling the same, which can reduce the time taken for activating a second communication system when transitioning from communication by way of a first communication system to communication by way of the second communication system.

The wireless terminal apparatus according to the present invention is a wireless terminal apparatus that can communicate via any one of a first communication system and a second communication system, and the wireless terminal apparatus includes: an acquisition unit that obtains a system time of the second communication system by synchronizing with the second communication system prior to activating the first communication system in a case in which communication is performed via the first communication system; a calculation unit that calculates a difference between a system time of the first communication system and the system time of the second communication system obtained by the acquisition unit; and a transition unit that calculates the system time of the second communication system based on the system time of the first communication system and the difference calculated by the calculation unit, and synchronizes with the second communication system based on the system time thus calculated, in a case of transitioning from communication via the first communication system to communication via the second communication system.

Moreover, it is preferable that the system time of the first communication system and the system time of the second communication system are reference time information used in each communication system.

In addition, it is preferable that the transition unit transitions to communication via the second communication system in a case in which an incoming call for the second communication system was reported in the first communication system.

Furthermore, it is preferable that the wireless terminal apparatus according to the present invention further includes a determination unit that determines whether the system time of the second communication system was reported, in a case in which an incoming call for the second communication system was reported in the first communication system, and in a case in which the system time of the second communication system was reported, the transition unit synchronizes with the second communication system based on the system time thus reported, and in a case in which the system time of the second communication system was not reported, the transition unit calculates the system time of the second communication system, and synchronizes with the second communication system based on the system time thus calculated.

Moreover, in a case in which the incoming call was reported, it is preferable that the transition unit transitions to the communication via the second communication system when obtaining an overhead message in the second communication system has succeeded, and searches for another second communication system as a transition destination when obtaining the overhead message in the second communication system has failed.

In addition, it is preferable that the acquisition unit synchronizes with the second communication system, and concurrently obtains the system time of the second communication system.

Furthermore, in a case in which handoff occurs with the first communication system, it is preferable that the acquisition unit suspends the first communication system, and then searches for another second communication system.

Moreover, it is preferable that the acquisition unit calculates the system time of the second communication system, based on a message for synchronization reported from a base station of the second communication system.

Moreover, it is preferable that the incoming call reported in the first communication system for the second communication system is received under a CS Fallback function specified in 3GPP TS 23.272.

In addition, it is preferable that the first communication system is of an LTE standard, and the second communication system is of a CDMA standard.

The control method according to the present invention is a method of controlling a wireless terminal apparatus that can communicate via any one of a first communication system and a second communication system, and the method includes the steps of: obtaining a system time of the second communication system by synchronizing with the second communication system prior to activating the first communication system in a case in which communication is performed via the first communication system; calculating a difference between a system time of the first communication system and the system time of the second communication system obtained in the step of obtaining, when activating the first communication system; and transitioning, when transitioning from communication via the first communication system to communication via the second communication system, by calculating the system time of the second communication system based on the system time of the first communication system and the difference calculated in the step of calculating, and then synchronizing with the second communication system based on the system time thus calculated.

According to the present invention, in a wireless communication apparatus, when transitioning from communication by way of a first communication system to communication by way of a second communication system, the time taken for activating the second communication system can be reduced.

### BRIEF DESCRIPTION OF THE DRAWINGS

FIG. 1 is a perspective view showing an appearance of a cellular telephone device according to an embodiment of the present invention;

FIG. 2 is a block diagram showing functions of the cellular telephone device according to the embodiment of the present invention;

FIG. 3 is a flowchart showing processing when turning on a power supply according to the embodiment of the present invention;

FIG. 4 is a flowchart showing processing in handoff according to the embodiment of the present invention; and

FIG. 5 is a flowchart showing processing when there is an incoming call according to the embodiment of the present invention.

### DETAILED DESCRIPTION OF THE INVENTION

A description is provided hereinafter for an example of an embodiment of the present invention. It should be noted that, in the present embodiment, a cellular telephone device 1 is described as an example of a wireless terminal apparatus.

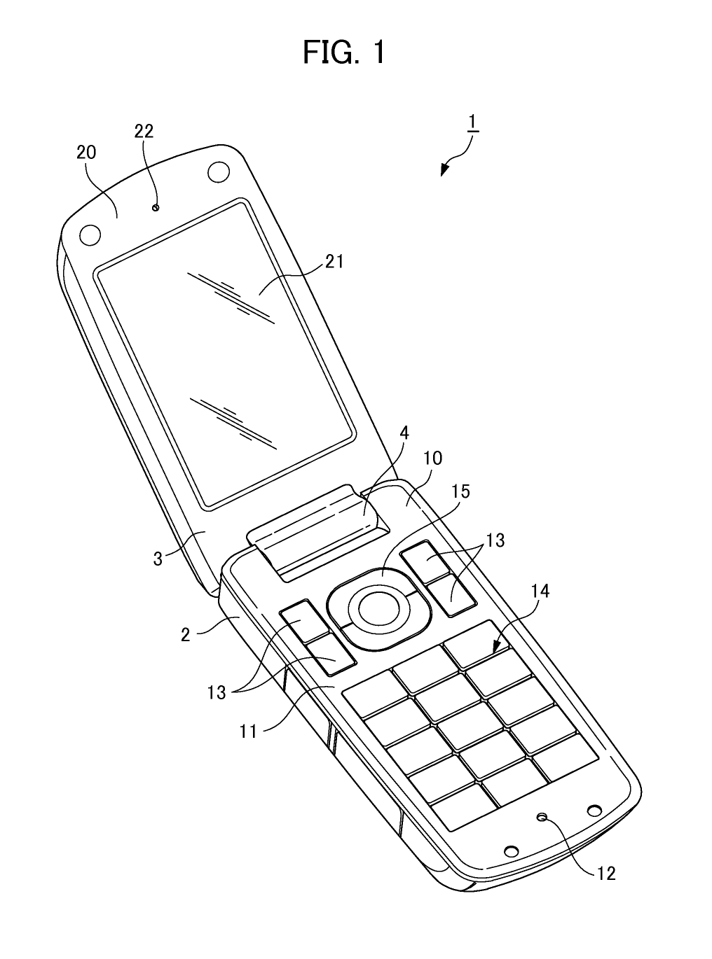

FIG. 1 is a perspective view showing an appearance of the cellular telephone device 1 according to the present embodiment. The cellular telephone device 1 is configured to include an operation unit side body 2 and a display unit side body 3. The operation unit side body 2 is configured to include, on a front face portion 10 thereof, an operation unit 11 and a microphone 12 to which sound produced by a user of the cellular telephone device 1 is input when the user is making a phone call or using a speech recognition application. The operation unit 11 is configured with: function setting operation buttons 13 for operating various functions such as for various setting functions, a telephone number directory function and a mail function; input operation buttons 14 for inputting the digits of a telephone number and characters for mail, etc.; and a selection operation button 15 for performing selection of various operations, scrolling, etc.

Moreover, the display unit side body 3 is configured to include, on a front face portion 20, a display unit 21 for displaying a variety of information, and a receiver 22 for outputting sound of the other party of the conversation.

In addition, an upper end portion of the operation unit side body 2 and a lower end portion of the display unit side body 3 are connected via a hinge mechanism 4. Furthermore, the cellular telephone device 1 can be arranged into a state where the operation unit side body 2 and the display unit side body 3 are apart from each other (opened state), and into a state where the operation unit side body 2 and the display unit side body 3 are contacting each other (folded state), by relatively rotating the operation unit side body 2 and the display unit side body 3, which are connected via the hinge mechanism 4.

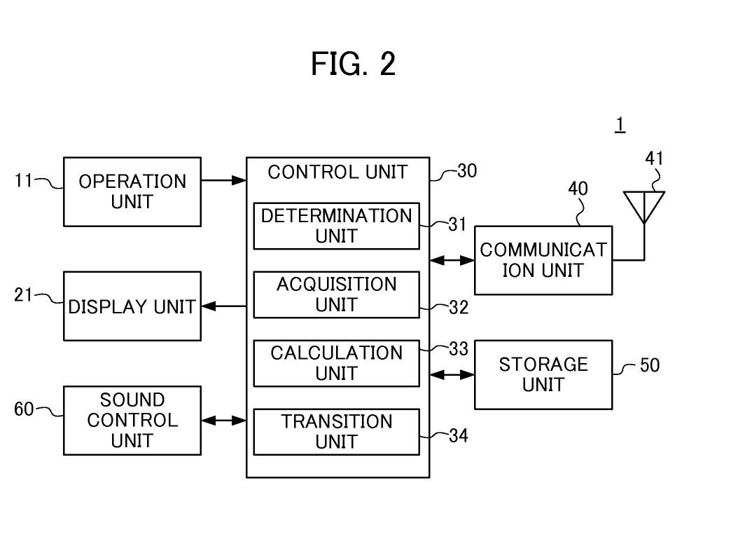

FIG. 2 is a block diagram showing functions of the cellular telephone device 1 according to the present embodiment. The cellular telephone device 1 includes the operation unit 11, the display unit 21, a control unit 30, a communication unit 40, an antenna 41, a storage unit 50, and a sound control unit 60.

The control unit 30 controls the entirety of the cellular telephone device 1, and performs, for example, predetermined control of the display unit 21, the communication unit 40, the sound control unit 60 and the like. Moreover, the control unit 30 accepts input from the operation unit 11 and the like to perform a variety of processing. In addition, when executing such processing, the control unit 30 controls the storage unit 50 to read various programs and data and write data. It should be noted that detailed functions of the control unit 30 according to the present embodiment will be described later.

The communication unit 40 communicates with external devices (base stations) at a predetermined usable frequency band (for example, 2 GHz band, 800 MHz band, and the like). Furthermore, the communication unit 40 performs demodulation processing on a signal received via the antenna 41 and provides the signal thus processed to the control unit 30, and in addition, performs modulation processing on a signal provided from the control unit 30 and transmits the signal to an external device via the antenna 41.

Here, in this example, the communication unit 40 conforms to both the CDMA2000_{—}1x (hereinafter referred to as CDMA) standard that is a communication protocol for audio and data communication, and the LTE standard that is a communication protocol mainly used for high speed data transmission; therefore, the communication unit 40 can perform communication in a communication system of either protocol. Based on an instruction from the control unit 30, the communication unit 40 communicates with a base station through any of the protocols. It should be noted that the cellular telephone device 1 shall perform data communication preferentially through LTE, and shall switch to CDMA when performing a voice call.

The storage unit 50 includes, for example, working memory, and is utilized for arithmetic processing by the control unit 30. Moreover, the storage unit 50 stores various programs according to the present embodiment. Furthermore, the storage unit 50 stores a system time, which is used in a communication system, and which is reference time information reported from a base station. By using the system time, the control unit 30 performs temporal synchronization with a base station to establish communication.

In accordance with control by the control unit 30, the sound control unit 60 performs predetermined sound processing on a signal transmitted from the communication unit 40, and outputs the signal thus processed to the receiver 22. The receiver 22 externally outputs the signal that is transmitted from the sound control unit 60. It should be noted that the signal may be output from a speaker (not illustrated) in place of the receiver 22 or in addition to the receiver 22. Moreover, in accordance with control by the control unit 30, the sound control unit 60 processes a signal, which is input from the microphone 12, and outputs the signal thus processed to the communication unit 40. The communication unit 40 performs predetermined processing on the signal transmitted from the sound control unit 60, and outputs the signal thus processed from the antenna 41.

Next, a detailed description is provided for functions of the control unit 30. The control unit 30 includes a determination unit 31, an acquisition unit 32, a calculation unit 33, and a transition unit 34.

In a case in which an incoming call through a CDMA communication system (a second communication system) was reported in the LTE communication system (a first communication system) by a CS Fallback function, the determination unit 31 determines whether the system time of the second communication system was reported.

Here, the CS Fallback function is one of the incoming call reporting services that are bridged between the LTE network and the CDMA network in a region where the physical areas of the LTE network and the CDMA network overlap with each other. More specifically, the CS Fallback function is a technique in which an incoming call for the cellular telephone device 1, of which the location is registered with the LTE network, is reported via the LTE network, and the cellular telephone device 1 that received this report transitions to the CDMA network to perform a voice call. In this technique, even for an incoming call via the CDMA network that essentially services voice calls, a management device on the network side performs coordination between the CDMA network call zone and the LTE network call zone. As a result, by registering the location of the cellular telephone device 1 with one among the CDMA network or the LTE network, the cellular telephone device 1 can operate as if the location thereof is registered with both the CDMA network and the LTE network.

In a case in which communication is performed via the first communication system (LTE), prior to activating the first communication system (LTE), the acquisition unit 32 synchronizes with the second communication system (CDMA) to obtain the system time of the second communication system (CDMA).

More specifically, when turning on the power supply of the cellular telephone device 1, the acquisition unit 32 synchronizes with the second communication system (CDMA) and concurrently obtains the system time of the second communication system (CDMA). Moreover, in a case in which handoff occurs with the first communication system (LTE), the acquisition unit 32 temporarily suspends the first communication system (LTE), then searches for the second communication system (CDMA), and synchronizes with the acquired second communication system (CDMA) to obtain the system time.

At this point in time, the acquisition unit 32 calculates the system time of the second communication system (CDMA), based on a message for synchronization on a synchronization (sync) channel reported from the base station of the second communication system (CDMA).

After the system time of the second communication system (CDMA) is obtained, and the first communication system (LTE) is activated, the calculation unit 33 calculates the difference between the system time obtained through the synchronization with the first communication system (LTE) and the system time of the second communication system (CDMA) obtained by the acquisition unit 32. The calculated difference is stored in the storage unit 50.

In a case in which the communication transitions from the first communication system (LTE) to the second communication system (CDMA) due to an incoming call for the second communication system (CDMA) being reported by the CS Fallback function while the first communication system (LTE) is activated, the transition unit 34 first refers to a determination result of the determination unit 31.

In a case in which the determination unit 31 determines that the system time of the second communication system (CDMA) was reported, the transition unit 34 synchronizes with the second communication system (CDMA) based on this reported system time. On the other hand, in a case in which the determination unit 31 determines that the system time of the second communication system (CDMA) was not reported, the transition unit 34 calculates the system time of the second communication system (CDMA), based on the system time of the first communication system (LTE) that is currently activated and the difference calculated by the calculation unit 33. In addition, based on the system time thus calculated, the transition unit 34 synchronizes with the second communication system (CDMA) that performs a voice call.

Here, in a case in which an incoming call for the second communication system (CDMA) was reported, the communication transitions to the second communication system (CDMA) when the transition unit 34 succeeds in obtaining an overhead message of the paging channel in the second communication system (CDMA) based on the system time calculated by the calculation unit 33. On the other hand, in a case in which the transition unit 34 fails in obtaining an overhead message, the transition unit 34 searches for the second communication system (CDMA) as a transition destination.

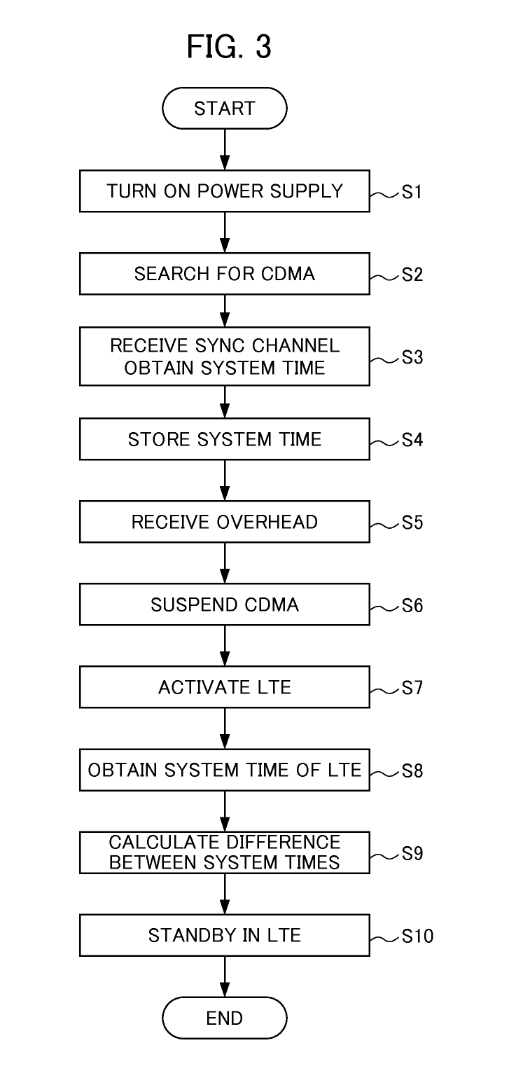

FIG. 3 is a flowchart showing processing when turning on the power supply of the cellular telephone device 1 according to the present embodiment.

In Step S1, when the power supply of the cellular telephone device 1 is turned ON, the control unit 30 performs predetermined activation processing, and starts acquiring a base station and processing of location registration.

In Step S2, the control unit 30 searches for the second communication system (CDMA) to acquire a pilot channel.

In Step S3, the control unit 30 establishes code synchronization with the second communication system (CDMA) to receive a sync channel, and obtains the system time thereof.

In Step S4, the control unit 30 stores, in the storage unit 50, the system time of the second communication system (CDMA) obtained in Step S3.

In Step S5, based on the system time obtained in Step S3, the control unit 30 establishes time synchronization with the second communication system (CDMA). In addition, the control unit 30 receives an overhead message of the paging channel in order to obtain a nearby channel, a base station location and the like, and further to obtain information (frequency channel, PN information, etc.) for establishing communication with the same second communication system (CDMA) a subsequent time.

In Step S6, the control unit 30 suspends the second communication system (CDMA) in order to activate the first communication system (LTE) that is given priority over the second communication system (CDMA).

In Step S7, the control unit 30 activates the first communication system (LTE), and starts synchronous processing.

In Step S8, the control unit 30 obtains the system time of the synchronized first communication system (LTE).

In Step S9, the control unit 30 calculates the difference between the system time of the first communication system (LTE) obtained in Step S8 and the system time of the second communication system (CDMA) obtained in Step S3, and stores the difference in the storage unit 50.

In Step S10, the control unit 30 enters a standby state for incoming communication in the first communication system (LTE), in which data communication can be performed in LTE, and incoming reporting of the second communication system (CDMA) by the CS Fallback function can be received.

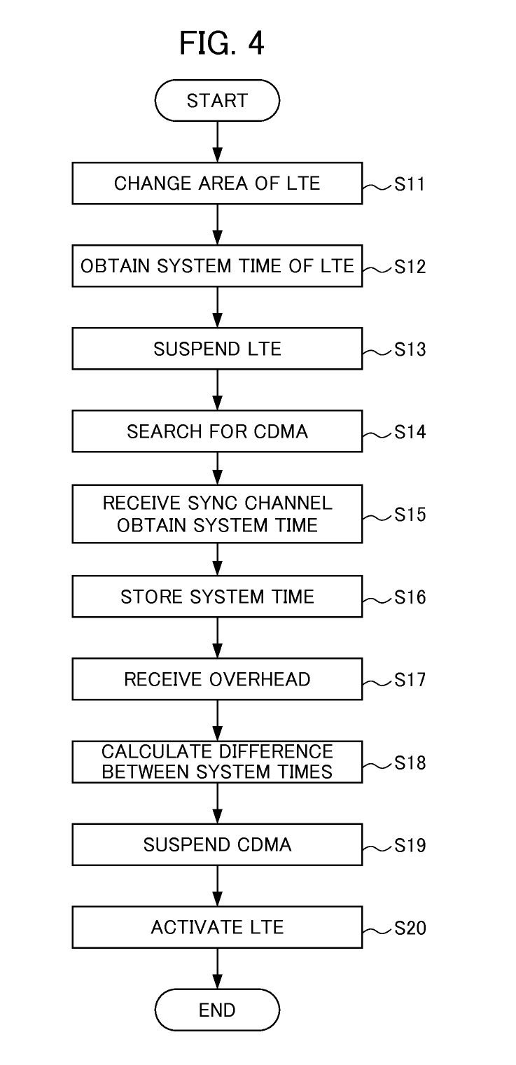

FIG. 4 is a flowchart showing processing in handoff of the cellular telephone device 1 according to the present embodiment.

In Step S11, based on a change in the status of the radio waves from the base station, the control unit 30 performs handoff that changes the area of the first communication system (LTE).

In Step S12, the control unit 30 obtains the system time of the first communication system (LTE) as the handoff destination, and stores the system time in the storage unit 50. Furthermore, the control unit 30 may obtain a frequency and PN information of the second communication system (CDMA) that is present nearby from the first communication system (LTE) as the handoff destination.

In Step S13, the control unit 30 temporarily suspends the first communication system (LTE) in order to acquire the second communication system (CDMA).

In Step S14, the control unit 30 searches for the second communication system (CDMA) to acquire a pilot channel. It should be noted that, in a case in which the frequency and PN information of the second communication system (CDMA) were obtained in Step S12, the control unit 30 can perform searching in a short period of time by limiting the search target to such information.

In Step S15, the control unit 30 establishes code synchronization with the second communication system (CDMA) to receive a sync channel, and obtains the system time thereof.

In Step S16, the control unit 30 stores, in the storage unit 50, the system time of the second communication system (CDMA) obtained in Step S15.

In Step S17, the control unit 30 receives an overhead message of the paging channel in order to establish time synchronization with the second communication system (CDMA) based on the system time obtained in Step S15, and in order to obtain information (a frequency channel, PN information, etc.) for establishing communication with the same second communication system (CDMA) a subsequent time.

In Step S18, the control unit 30 calculates the difference between the system time of the first communication system (LTE) obtained in Step S12 and the system time of the second communication system (CDMA) obtained in Step S15, and stores the difference in the storage unit 50.

In Step S19, in order to activate the first communication system (LTE) that was suspended in Step S13, the control unit 30 suspends the second communication system (CDMA).

In Step S20, the control unit 30 activates the first communication system (LTE) to enter a standby state for incoming communication, in which data communication can be performed in LTE, and incoming reporting of the second communication system (CDMA) by the CS Fallback function can be received.

It should be noted that, in this processing, the calculation of the difference of the system time (Step S18) may use the system time obtained after activating the first communication system (LTE) (Step S20).

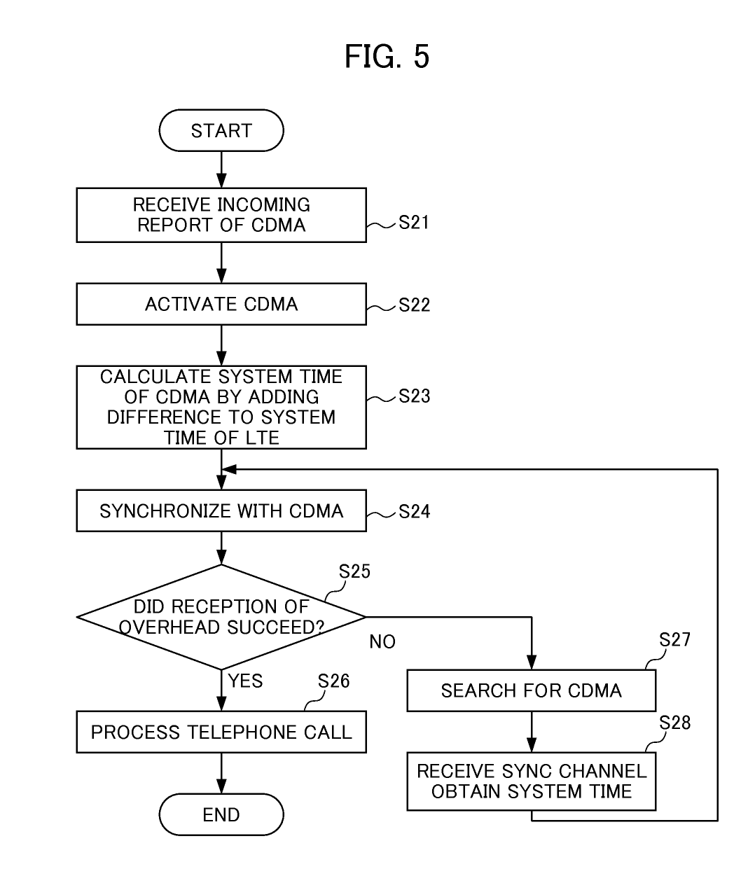

FIG. 5 is a flowchart showing processing of the cellular telephone device 1 according to the present embodiment when there is an incoming call.

In Step S21, the control unit 30 receives an incoming call reporting message of the second communication system (CDMA) by the CS Fallback function.

In Step S22, after responding to the incoming reporting received in Step S21 via the first communication system (LTE), the control unit 30 activates the second communication system (CDMA) in order to start processing of a telephone call.

In Step S23, the control unit 30 calculates the system time of the second communication system (CDMA) by adding a correction value to the system time of the first communication system (LTE).

In Step S24, the control unit 30 establishes synchronization with the second communication system (CDMA) by using the system time calculated in Step S23, and attempts to receive a paging channel.

In Step S25, the control unit 30 determines whether reception of the overhead message of the paging channel succeeded in the second communication system (CDMA). In a case in which the determination is YES, the control unit 30 advances the processing to Step S26, and in a case in which the determination is NO, the control unit 30 advances the processing to Step S27.

In Step S26, the control unit 30 transitions to a traffic channel in the second communication system (CDMA) to perform processing of a telephone call.

In Step S27, since the control unit 30 has failed in the time synchronization with the second communication system (CDMA) by using the system time calculated in Step S23, the control unit 30 searches for a second communication system (CDMA) allowing communication.

In Step S28, the control unit 30 receives a sync channel of the acquired second communication system (CDMA), and obtains the system time thereof. In addition, the control unit 30 returns the processing to Step S24, and attempts to receive a paging channel again.

As described above, according to the present embodiment, the cellular telephone device 1 calculates and stores the difference between the system time of LTE and the system time of CDMA. As a result, in a case in which an incoming call for the CDMA communication system was reported in the LTE communication system, the cellular telephone device 1 can calculate the system time of CDMA based on the system time of LTE and the difference thus stored. As a result, when transitioning from the LTE communication to the CDMA communication, the cellular telephone device 1 can reduce the processing of search and synchronization, and can reduce the time for activating CDMA. It should be noted that the transitioning to CDMA communication is not limited to a case of receiving an incoming call, and is similar in a case of receiving an outgoing call request as well.

Moreover, since the cellular telephone device 1 determines whether the system time of the CDMA communication system was reported in the LTE communication system, the system time may be calculated only when the system time is not reported, and the processing load can be reduced when the system time is reported.

In addition, the cellular telephone device 1 performs transition to communication in a case in which obtaining an overhead message in the CDMA communication system has succeeded by way of the calculated system time of CDMA, and searches for a transition destination in a case in which obtaining an overhead message has failed; therefore, the cellular telephone device 1 can transition to the CDMA communication system more reliably.

Furthermore, when the power supply is turned on and when handoff occurs, the cellular telephone device 1 searches for a CDMA communication system and obtains the system time of CDMA. Therefore, since the cellular telephone device 1 calculates the difference through limiting to the timing at which the system time may fluctuate, the processing load and the power consumption are reduced without activating CDMA in every specific cycle.

Although an embodiment of the present invention has been described above, the present invention is not limited to the aforementioned embodiment. Moreover, the effects described in the embodiment of the present invention merely exemplify the most preferable effects arising from the present invention, and the effects according to the present invention are not limited to those described in the embodiment of the present invention.

The CDMA2000_{—}1x standard and the LTE standard in the aforementioned embodiment are merely examples, and another communication protocol may be employed. For example, a case of employing the W-CDMA standard and the LTE standard is similar thereto.

Furthermore, the wireless terminal apparatus according to the present invention is not limited to the cellular telephone device 1, and it may be applied to various terminal devices such as a PHS (trademark: Personal Handyphone System) and a PDA (Personal Digital Assistant), and in addition, a gaming machine, a navigation device, a personal computer and the like.

What is claimed is:

1. A wireless terminal apparatus that can communicate via any one of a first communication system and a second communication system, the wireless terminal apparatus comprising:
an acquisition unit that obtains a system time of the second communication system by synchronizing with the second communication system prior to activating the first communication system in a case in which communication is performed via the first communication system;
a calculation unit that calculates a difference between a system time of the first communication system and the system time of the second communication system obtained by the acquisition unit; and
a transition unit that calculates the system time of the second communication system based on the system time of the first communication system and the difference calculated by the calculation unit, and synchronizes with the second communication system based on the system time thus calculated, in a case of transitioning from communication via the first communication system to communication via the second communication system.

2. The wireless terminal apparatus according to claim 1, wherein the system time of the first communication system and the system time of the second communication system are reference time information used in each communication system.

3. The wireless terminal apparatus according to claim 1, wherein the transition unit transitions to communication via the second communication system in a case in which an incoming call for the second communication system was reported in the first communication system.

4. The wireless terminal apparatus according to claim 3, further comprising:
a determination unit that determines whether the system time of the second communication system was reported, in a case in which an incoming call for the second communication system was reported in the first communication system,
wherein, in a case in which the system time of the second communication system was reported, the transition unit synchronizes with the second communication system based on the system time thus reported, and in a case in which the system time of the second communication system was not reported, the transition unit calculates the system time of the second communication system, and synchronizes with the second communication system based on the system time thus calculated.

5. The wireless terminal apparatus according to claim 3, wherein, in a case in which the incoming call was reported, the transition unit transitions to the communication via the second communication system when obtaining an overhead message in the second communication system has succeeded, and searches for another second communication system as a transition destination when obtaining of the overhead message in the second communication system has failed.

6. The wireless terminal apparatus according to claim 1, wherein the acquisition unit synchronizes with the second communication system, and concurrently obtains the system time of the second communication system.

7. The wireless terminal apparatus according to claim 1, wherein, in a case in which handoff occurs at the first communication system, the acquisition unit suspends the first communication system, and then searches for another second communication system.

8. The wireless terminal apparatus according to claim 1, wherein the acquisition unit calculates the system time of the second communication system, based on a message for synchronization reported from a base station of the second communication system.

9. The wireless terminal apparatus according to claim 3, wherein the incoming call reported in the first communication system for the second communication system is received under a CS Fallback function specified in 3GPP TS 23.272.

10. The wireless terminal apparatus according to claim 9, wherein the first communication system is of a LTE standard protocol, and the second communication system is of a CDMA standard protocol.

11. A method of controlling a wireless terminal apparatus that can communicate via any one of a first communication system and a second communication system, the method comprising the steps of:
obtaining a system time of the second communication system by synchronizing with the second communication system prior to activating the first communication system in a case in which communication is performed via the first communication system;
calculating a difference between a system time of the first communication system and the system time of the second communication system obtained in the step of obtaining, when activating the first communication system; and
transitioning, when transitioning from communication via the first communication system to communication via the second communication system, by calculating the system time of the second communication system based on the system time of the first communication system and the difference calculated in the step of calculating, and then synchronizing with the second communication system based on the system time thus calculated.
